(19) United States
(12) Patent Application Publication
(10) Pub. No.: US 2008/0077485 A1
(43) Pub. Date: Mar. 27, 2008

(54) Network Marketing Referral Method and Tracking System

(76) Inventor: Kurt Scrudato, Liverpool, NY (US)

Correspondence Address: BOND, SCHOENECK & KING, PLLC, ONE LINCOLN CENTER, SYRACUSE, NY, 13202-1355, US

(21) Appl. No.: 11/535,312

(22) Filed: Sep. 26, 2006

(51) Int. Cl. G06Q 30/00

(52) U.S. Cl. 705/14

(57) ABSTRACT

A network marketing system is disclosed that provides classified and auction sales of goods and services produced and offered for sale by network users rather than the proponent of the network. The system includes rewards for network members for recruiting additional members and for the sale of goods and services by a member's down line. To encourage recruitment of new members and to properly record member rewards, each member is assigned a unique identifier. The identifier is associated with that member's recruits so that the system directs rewards to the proper recruiting member based on, for example, membership fees and sales made by the recruits. The system allows users to offer goods for a price below their market value in exchange for a purchaser recruiting a designated number of new network members.

### BACKGROUND OF THE INVENTION

The present invention relates to a method of selling goods and services using a global computer network and multi-level marketing incentives.

### SUMMARY OF THE INVENTION

Existing multi-level (or “network”) marketing systems reward network members for sale of goods that are produced and/or distributed by the proponent of the network. The proponent of the network marketing system therefore must produce and distribute goods that will be sold through its network. Such systems are not readily adapted to sale of goods or services that are not produced or distributed by the network's proponent. For example, such systems are not readily adapted to allow network members to sell goods or services that network members produce or distribute independent of the network proponent.

It is therefore a principal object and advantage of the present invention to provide a network marketing system that allows network members to offer and sell goods and services that network members produce independent of the network proponent.

In accordance with the foregoing objects and advantages, the present invention provides a network marketing system for classified and auction sales.

The network marketing system of the present invention improves upon traditional network marketing systems by eliminating physical products at the company level, which simplifies the operation of the network proponent. The system still provides the opportunity for sale of physical products at the member level because it allows members to sell their own items through the system's classified or auction services. In effect, the system of the present invention sells “services” via a global computer network, not physical products; according to the system of the present invention, system members can sell and exchange their own physical products or services within the system's online service site. Selling services as opposed to products is advantageous to the network proponent because physical products being sold from the company level require additional effort (and expense) for manufacturing, inventory storage, shipping, etc., which presents additional burdens and costs for the network proponent.

The network marketing system of the present invention improves network marketing by selling something that is innocuous, non-offensive, proven, tested, in demand, accepted and valuable. Network marketing companies are often limited by selling new, unknown products that are not tested, proven, accepted and therefore not consumed. By incorporating a clean, simple, innocuous, widely accepted service (i.e., online classified and auction sales) to sell through network marketing, the present invention creates a powerful, valuable tool for individuals, businesses and not for profit organizations.

Many existing network marketing operations are plagued and limited by the products they sell. Some unproven products are embarrassing to sell and create awkward selling situations that ultimately create failure for the independent distributor/member and the company. The system disclosed in the present invention offers services that are widely accepted, needed, wanted, valued and sell themselves, which insures success both for the network member and the network proponent.

The system of the present invention improves online classified/auction services by creating tight regionalization, meaning that a seller or buyer can be exchanging goods or services with someone right in their neighborhood. This community approach goes hand and hand with fundamental principle of network marketing: people telling other people by word of mouth.

The system of the present invention also improves online classified/auctions services by better organizing listings and making it easy and affordable to list items of all values, even items of no value to the seller. Some online classified/auction sites, like Craigslist™, are free; others, like eBay™, require payment from users. The system of the present invention is different in that it is better than free. The system pays members for every new member that they recruit. This organized, affordable, easy and very localized community-oriented service makes it compatible with fundamental principles of network marketing: people helping other people.

By combining a regionally tight online classified and auction service with a network marketing structure, the system of the present invention draws upon local word of mouth advertising within each community. Services and opportunity travel by word of mouth, by email and through other cutting edge online communication methods, without the traditional face-to-face awkwardness and discomfort associated with existing network marketing operations. The discomfort and or awkwardness normally associated with selling product or services in existing network marketing operations is diminished or eliminated. The services provided through the present invention—online classified and auctions—are known, accepted and valued; as a result they sell themselves. No awkwardness is associated with telling someone about an innocuous group of services with which most people are already familiar.

### BRIEF DESCRIPTION OF THE DRAWINGS

The present invention will be more fully understood and appreciated by reading the following Detailed Description in conjunction with the accompanying drawings, in which:

FIG. 1 is a functional block diagram showing an embodiment of the invention; and

FIG. 2 is a flow chart showing the member registration and incentive award process according to an embodiment of the invention.

### DETAILED DESCRIPTION

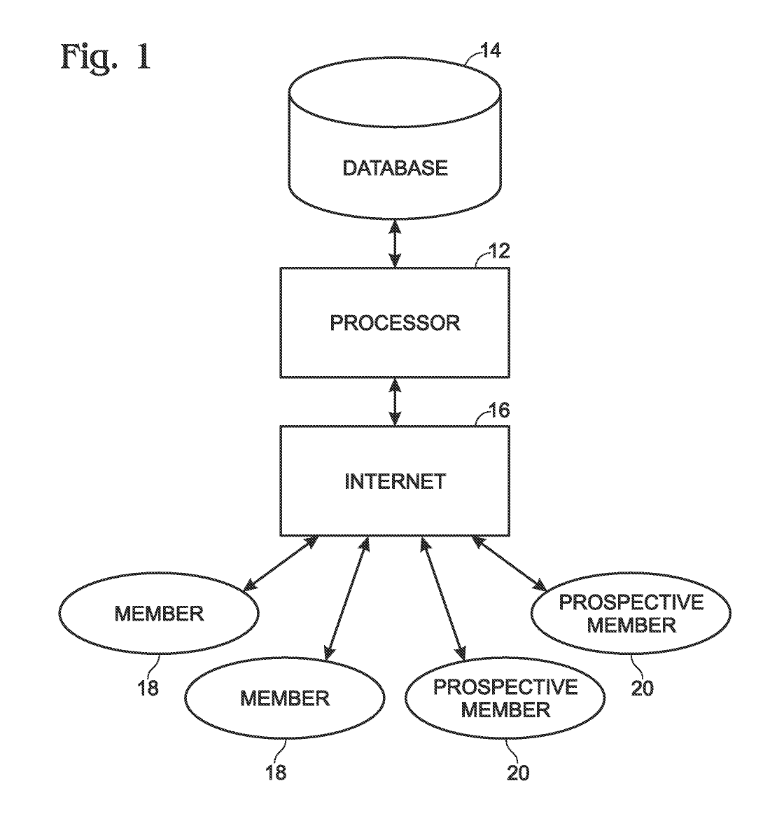

Referring now to the drawings, wherein like reference numerals refer to like parts throughout, there is seen in FIG. 1 a functional block diagram representing components of a network marketing referral and tracking system 10 according to an embodiment of the present invention. The system comprises at least one computer processor or server 12, which tracks membership in the system, administers classified advertisements and auction sales, and generates unique identifiers (key codes) used to allocate member commissions. Membership data for the system 10 is stored on at least one database 14. The system includes an internet interface 16 through which goods and services are offered for sale and sold by members 18. The internet interface also is used to recruit new members 20. Computer programs for administering classified and auction sales on the internet are known in the art and need not be described further. Similarly, computer programs for administering network marketing systems are known to those skilled in the art and need not be described further.

A network marketing system according to the present invention sells classified and auction services to private individuals and businesses—both for profit and not for profit. The system offers to private individuals, businesses and not for profit companies an opportunity to generate income. A network marketing system according to the present invention quickly delivers services world wide via the Internet to a large number of potential users and purchasers.

The network marketing system according to the present invention further organizes and regionalizes the classified market place, making it easier to sell or give away a broader range of items with both high value, low value and no value to the lister. The system's tight regionalization makes it equitable to sell items of low value that are not worth shipping. The system also has better organized classifieds to make is more user friendly for buyers and sellers.

The system according to the present invention requires a unique member identifier, or key code. Each member's key code is used as part of the new member referral process so that new members are automatically associated in the system with the member that referred them (which is an essential part of network marketing). Unique key codes are assigned by the system processor 12 at the time a new member registers. Preferably, key codes are alphanumeric strings of sufficient length to provide unique identifiers to each member of the system. According to one embodiment, members are permitted to select an alias that can be a more easily remembered word, phrase or alphanumeric combination. According to this embodiment, each member's alias is associated in database 14 with the member's key code. In selecting an alias, processor 12 queries database 14 to determine if a requested alias is distinct from other aliases stored in the database 14 and will only assign the requested alias if it is unique. According to this embodiment, a member's alias can be used in place of the member's key code.

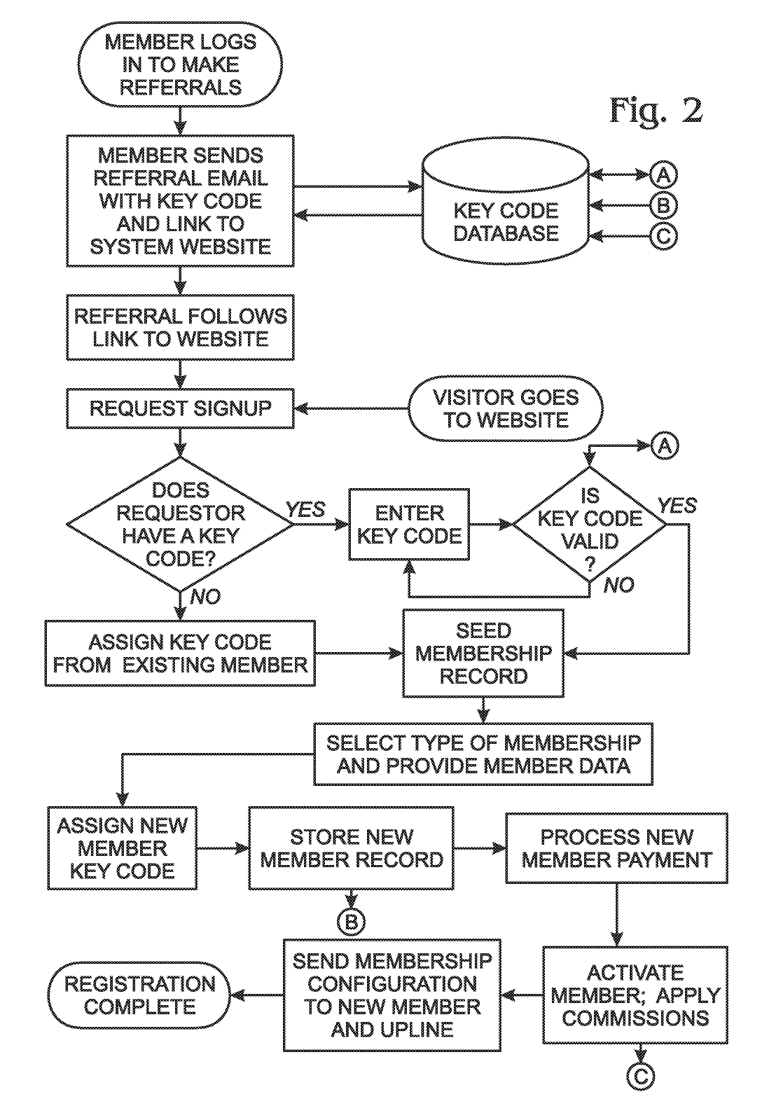

Referring now to FIG. 2, there is shown a flow chart that explains an embodiment of the invention. An existing member logs on to the system website to retrieve the member's key code. Alternatively, a member can store a key code remotely, on a database other than the system key code database (for example, on the member's personal computer, on a server associated with a website other than the system website, or written down in text form). As described above, the invention contemplates that members may use easily remembered aliases in place of their key codes.

Next, the member sends a message to a prospective member, inviting the prospect to become a system member. Preferably, the message is an email message that includes the member's key code and a link to the system's member sign up page. Alternatively, the message can be a medium other than email, provided that it either provides the member's key code or directs the prospective member to a location where the member's key code can be retrieved and, ultimately, directs the prospective member to the system's member sign up page.

As part of the system sign up process, the prospective member provides the referring member's key code, which is compared to the key code database. If the key code is valid, the processor generates a seed that is associated with the prospective member's membership record.

If a prospective member is not referred to the system by an existing member, the prospective member will not have a key code that allows the prospective member's membership record to be seeded. In this case, the prospective member will be offered an opportunity to select from a plurality of sponsoring advertisers and will be provided the key code associated with the selected advertiser. This key code will then be used as if it were provided by an existing member and will result in seeding of the prospective member's membership record.

After the prospective member's membership record has been seeded, the prospective member provides information required for the prospective member's membership record. For example, the prospective member may select from a plurality of types of membership, such as business, private, or non-profit or may select from a variety of membership term lengths. The prospective member also provides membership data, such as contact information and financial account information. Upon receipt of the prospective member's membership data, the system's processor assigns the member a key code and stores the prospective member's data in the system's databases.

Using the financial account information provided by the prospective member, the system's processor processes the prospective member's payment (preferably using an online payment system such as PayPal™). After the prospective member's payment is confirmed, the prospective (now “new”) member's membership is activated, the “pending” flag is removed and commissions associated with the new member are applied. According to the present invention, a portion of the commission associated with the new member is paid to the new member's upline, beginning with the referring member. Another portion of the commission is paid to the system operator.

After the commissions have been applied, a confirmation notice is provided to the new member and to the new member's upline. The new member's registration is now complete. The new member may now log on to the system processor to obtain his key code and may provide the key code to additional prospective members.

The network marketing system of the present invention couples the sale of online classified advertising services and online auctions services with a network marketing and compensation plan. This coupling of services, marketing plan and compensation plan is performed through a central website. Each member registers for an account that allows the member to market goods and services using the website's online classified and auction services. Membership is not required to purchase goods or services offered for sale using the system. According to one embodiment, individuals and companies become members of the system upon payment of an annual fee that allows the member to make an unlimited number of offerings of that member's goods services using the system. As part of each member's registration, the processor generates a personal key code. Each member's personal key code is provided to the member as part of the registration process and stored in database 14. As described above, according to one embodiment of the invention, members may select a more easily remembered alias that is associated in the database with the member's key code and may be used in place of the member's key code. When recruiting prospective members, an existing member provides his key code (or alias) to each prospective new member that he recruits. If the prospective new member elects to become a member of the system, she will be required to provide the key code (or alias) of the existing member that recruited her for membership, which will be compared by the processor 12 with the recruiting member's stored key code to insure that the recruiting member receives credit for recruiting a new member. The registration system requires each new registrant to provide a recruiting member's key code; no one can register without a key code.

Preferably, when a prospective member is contacted with information about the system, the key code of the recruiting member is delivered automatically. Upon the prospective member's registration as an active member, the recruiting member receives credit for the recruit and automatically receives commissions based on the new member's commission-generating activity on the system. There are several ways for a prospective member to get a key code.

For example, an existing member can provide his key code manually, automatically via email, automatically via a web browser hotlink or imbedded within an email or link. System members that have a website can include a system link on their site that automatically provides the member's key code.

Alternatively, if a prospective member does not have a key code, the prospective member will be offered an opportunity during registration to pick from a drop down list of preferred advertisers that are affiliated with the system; when a preferred advertiser is selected, the registration software automatically provides a key code that is associated with the selected advertiser.

As yet another alternative, if a purchaser arrives at the system website as the result of a search for a specific item and decides to become a member, the purchaser will be provided the key code associated with the item's seller, which is available from a link on the page that includes the item listing. All members who list items have their key code displayed in connection with each members' sale listings. By including the selling member's key code with the listing information of each item the member is selling, members have an incentive to offer many items for sale. This supports the system by encouraging a large volume of goods and services for sale.

Members receive commissions based on activity that promotes and expands the system. As with other network marketing systems, members receive commissions based on the commission generating activity of their entire down line, which includes each of their recruits and the members that the recruits directly and indirectly recruit. According to one embodiment, member commissions are based on the number of new members that each member recruits to join the system, for example a percentage of the membership fee paid by a member's recruits. Alternatively, member commissions can be based on the value of goods and services sold by a member's down line. Yet another alternative is for commissions to be calculated based on a combination of member recruitment and a percentage of the value of goods and services sold by a member's down line. Member commissions are calculated based on commission generating activity that is recorded and stored in the system's computer processor.

Members list items on the system website for sale or auction. For members, lower sale prices can be subsidized by profits gained through compensation derived from recruitment of new members. In general, goods and or services can be listed/priced aggressively to attract buyers who can become new members, who in turn do the same things. Goods and services can now be priced below market value and even for no cost by substituting a membership recruiting quantity requirement in lieu of some or all of the purchase price.

For example, an item with a market value of $100 could be offered for sale for $50 along with a requirement for the buyer to become a member and recruit enough members below them to compensate for the reduced selling price. Similarly, an item could be offered for free, along with a requirement that the recipient recruit a specified number of system memberships. The number of memberships would be selected by the person offering the item. Generally, the number would be sufficient to subsidize the cost of the item, but the offeror could require more or fewer memberships. If the item being offered is unique or available only in limited quantities, the offeror can establish terms on the sale page that specify how the offeror will distinguish between a plurality of individuals who satisfy the membership recruitment requirement.

Upon registration members are encouraged and sometimes required to list their items aggressively for sale or for free on the system. This ensures that the system is full of desirable items priced aggressively, which further attracts buyers and/or new members. The system includes online tools to assist members in recruiting new members from their contacts. The system allows members to send out email messages with their “Key Code” embedded, or with a link to a webpage to permit a prospective member register. As described above, the message recipients then register and credit for their recruitment is passed to the recruiting member; commissions from commissionable activity by the new member (and other members s/he recruits) are processed by the system automatically and are paid to the recruiting member through his system account.

What is claimed is:

1. A method for tracking and paying commissions based on member referrals in a network marketing system having a plurality of members, the method comprising the following steps:
assigning a unique identifier to each network marketing system existing member;
providing an existing member's unique identifier to a prospective system member;
using the existing member's information to create an association between the existing member and prospective member;
saving data about said existing member and said prospective member, including information about the association;
paying a commission to said existing member based on the association with said prospective member.

2. The method of claim 1, wherein said unique identifier is an alias for an alphanumeric key code.

3. The method of claim 1, further comprising:
processing said prospective member's membership application.

4. The method of claim 3 wherein the step of processing includes requesting the prospective member's desired membership type.

5. The method of claim 3 wherein the step of processing includes requesting the prospective member's financial institution information and initiating an electronic transfer of funds in payment of the prospective member's membership fee.

6. The method of claim 5, wherein the commission is a percentage of said prospective member's membership fee.

7. The method of claim 5, wherein the commission comprises a percentage of the value of goods and services sold by said prospective member through the system.

8. The method of claim 3 wherein the step of processing includes assigning the prospective member a unique identifier.

9. The method of claim 1, wherein the step of providing an existing member's unique identifier to a prospective system member further comprises:
storing said unique identifier in a database; and
transmitting said unique identifier to said prospective member in response to a request by said existing member.

10. The method of claim 1, wherein the step of providing an existing member's unique identifier to a prospective system member further comprises:
storing said unique identifier in a database;
and transmitting said unique identifier to said prospective member in response to a request by said prospective member.

11. A method for tracking and paying commissions based on member referrals in a network marketing system comprising the following steps:
assigning a unique identifier to each network marketing system member;
receiving a request for membership from a prospective member;
providing said prospective member with a an existing member's unique identifier;
using the existing member's unique identifier to create an association between the existing member and prospective member;
saving data about said existing member and said prospective member, including information about the association;
paying a commission to said existing member based on the association with said prospective member.

12. The method of claim 11 wherein the step of providing said prospective member with an existing member's unique identifier comprises displaying said existing member's unique identifier in conjunction with a sale offering.

13. The method of claim 11 wherein the step of providing said prospective member with a an existing member's unique identifier comprises providing a list of existing members, each logically associated with its unique identifier, and requiring said prospective member to select an existing member from said list.

14. The method of claim 11 wherein the step of providing said prospective member with an existing member's unique identifier comprises displaying a hyperlink to said existing member's unique identifier in conjunction with a sale offering.

15. A membership system for network marketing among a plurality of members, each member being assigned a unique identifier, comprising:
A processor, said processor for generating and serving sale pages over a world wide computer network, said processor including an algorithm for completing sale transactions wherein a member establishes a selling price that includes performance of a service by a buyer;
A database for storing information about each of said members, including the unique identifier of each member.

16. The system of claim 15 wherein the service is recruiting a specified number of new members.

17. The system of claim 15 wherein said processor includes an algorithm for associating a recruited member with an existing member that recruited the new member and wherein said processor provides commission payment instructions based on said association.

18. The system of claim 15 wherein said processor includes an algorithm for associating a new member with an existing member selected by the new member from a list of existing members generated by the processor and wherein said processor provides commission payment instructions based on said association.
